(19) United States
(12) Patent Application Publication
(10) Pub. No.: US 2004/0034590 A1
(43) Pub. Date: Feb. 19, 2004

(54) On-line auction

(76) Inventor: David Zinberg, Malibu, CA (US)

Correspondence Address: Robert A. Seldon, Birch, Stewart, Kolasch & Birch, Suite 1800, 10940 Wilshire Blvd., Los Angeles, CA, 90024-3945, US

(21) Appl. No.: 10/223,142

(22) Filed: Aug. 19, 2002

(51) Int. Cl. G06F 17/60

(52) U.S. Cl. 705/37

(57) ABSTRACT

A novel on-line auction is disclosed which defines a very short initial time in which the auction on a particular item is to take place; preferably 5 minutes or less. The auction closes at the end of the period, with the highest bidder obtaining the object (subject to any reserve or minimum bid requirements which are preferably lacking). If, however, a bid is received during a pre-defined end portion of the initial period that is known to the bidders, the auction period is extended for a short supplemental period. Thereafter, the process is preferably repeated, with a bid during a known pre-defined end portion of the then-existing supplemental period causing the auction to be extended for another supplemental period. This cycle repeats itself until no bid is received during the end portion of the then-existing supplemental period.

### BACKGROUND

1. Field Of The Invention

This invention relates to the field of on-line auctions using a computer network, and in particular to a novel auction structure.

2. Description of the Prior Art

On-line auctions are an increasingly popular vehicle for buying and selling merchandise. In addition to the ability of on-line auctions to attract consumers and sellers from around the globe, these auctions provide an excitement that transcends the comparatively mundane purchasing of fixed-price items.

The structure of the conventional on-line auction is well known. An item is offered for a fixed time period, sometimes with a minimum starting bid and sometimes with a reserve; i.e., the item is withdrawn if a desired minimally acceptable amount is not bid. At the end of the fixed period, the highest bidder obtains the item subject to any reserve or minimum bid requirements.

### SUMMARY OF THE INVENTION

To increase the excitement and foster rapid and higher bidding, the invention herein is a novelly structured auction that utilizes available on-line auction coding to create a new type of auction. First, a very short initial time period is defined in which the auction on a particular item is to take place; preferably 5 minutes or less. The auction closes at the end of the period, with the highest bidder obtaining the object (subject to any reserve or minimum bid requirements which are preferably lacking). However, if a bid is received during a pre-defined end portion of the initial period (preferably, 1 minute or less) that is known to the bidders, the auction period is extended for a supplemental period (preferably 1 minute or less). Thereafter, the process is preferably repeated, with a bid during a known pre-defined end portion of the then-existing supplemental period causing the auction to be extended for another supplemental period. This cycle repeats itself until no bid is received during the end portion of the then-existing supplemental period.

Those skilled in the art will recognize that the number of supplemental periods can be limited, each supplemental period can be different in length, and each pre-defined end portion can be different in length without departing from the scope of the invention.

### THE DRAWING

FIG. 1 herein is a flow chart illustrating the structure of a preferred auction structured in accordance with the invention; and

FIG. 2 is an illustration in schematic of a preferred website page for conducting an auction in accordance with the invention.

### DESCRIPTION OF THE PREFERRED EMBODIMENT

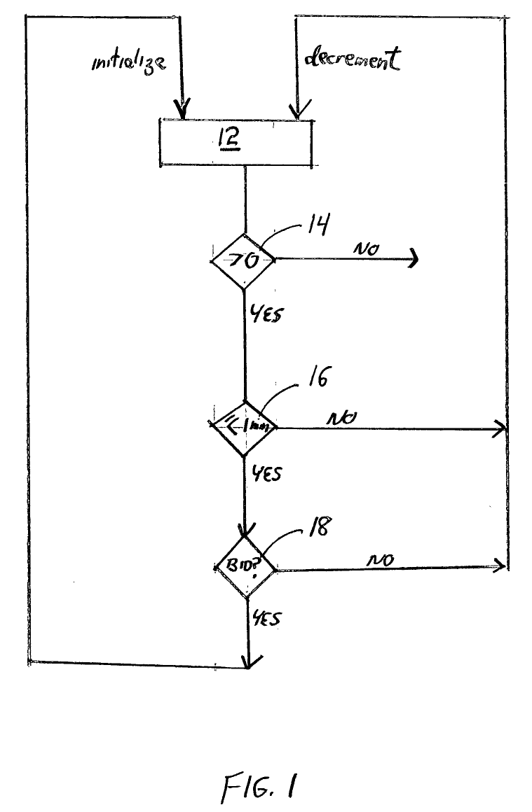

Referring initially to FIG. 1, a flow chart is presented for a 3 minute auction; that is, an auction having an initially defined length of 3 minutes. Three minutes is believed to provide a sufficient period of time for a viewer to read a description of the item, utilize on-line sources to help evaluate his/her interest in the item, return to the web page and submit a bid while maintaining a level of energy and emotional involvement contusive to a lively and effective auction. It should be understood that auction having an initially defined length of more or less than 3 minutes can be structured in accordance with the invention.

The basic auction structure of the invention comprises a timing loop 10 for each auctioned item. The timing loop 10 is configured to provide an initial 3-minute auction period, which is extended for successive 1-minute periods if a bid is received during the last one minute of the then-operative period.

The timing loop comprises a register 12 that is initialized to count from an upper limit value to a lower limit value during a three-minute period. For simplicity, it will be assumed for the purpose of this discussion that the upper limit value is 180 (i.e., the number of seconds in a three minute period) and that the lower limit value is zero. Those skilled in the art will recognize from the ensuing description that the actual values will depend on the clock frequency of the system, software coding, and other such user-chosen parameters selected for convenience and/or efficiency.

Upon reaching the lower limit, the timer terminates the auction on the item. Barring any intervening events, the register in the illustrated embodiment will count down from 360 towards zero at a clock rate of 1/sec. With each clock pulse, the existing count in the register 12 is applied to a logic gate 14 which determined if the count has reached zero. If it has, the auction on the item is terminated. If the count is not zero, a second logic gate 16 determines whether the count is less than 60; i.e., whether one minute or less remains. If more than one minute remains, the next clock pulse decrements the register 12. If one minute or less remains, a third logic gate 18 is used to determine if a bid has come in. If no bid has come in, the next clock pulse decrements the register 12. If a bid has come in, the register is re-initalized to provide a full minute, and process repeats until no bid is received during the last minute of permissible bidding.

Those skilled in the art will recognize that software code may be used instead of electronic logic gates to perform the foregoing logic functions. In addition, multiple re-initializations of the register may be for different periods rather that identical periods, and the window within which bids must be made in order to extend the period for bid acceptance may also be varied with each re-initialization.

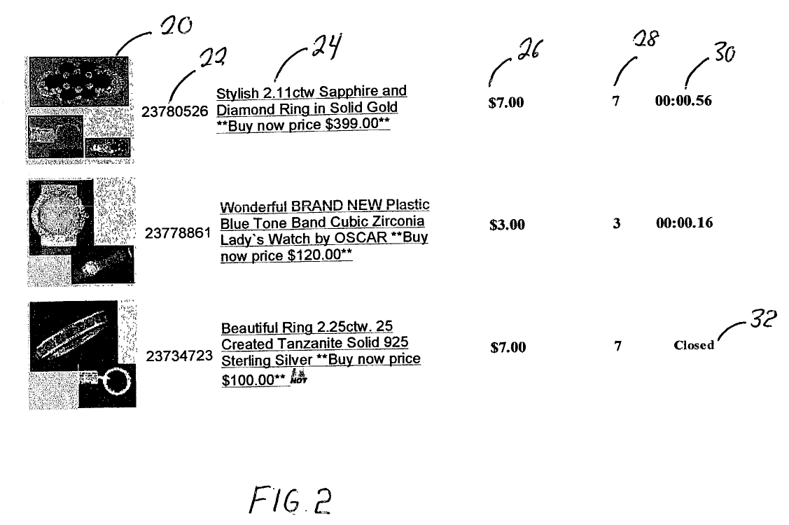

FIG. 2 is an illustration in schematic of a preferred website page for conducting an auction in accordance with the invention. In accordance with the invention, bids are posted in real time; that is, a viewer watches the bidding action as it takes place, and can submit bids as (s)he is watching.

The preferred web page comprises a thumbnail 20 of the auctioned item, an item number 22, a hyperlinked description 24 of the item, the current bid 26, the number of bids 28 on the item thus far and the amount 30 of time remaining in which to bid on the item. The hyperlinked description leads to a page displaying the time remaining, the ten-winning bid and winning bidder, bid history, and a link for placing a bid.

The display of the amount of time 30 for each item can be coded to flash an eye-catching icon during the last 10-15 seconds (or other desirable period) of bid acceptance, such as a red rectangular box with the words “last call” or the like to stimulate bidding. The flashing icon can be accompanied by a tone or other sound to alert the viewer and draw attention to the item. At the conclusion of the bidding, the displayed amount of time is replaced by the term “closed”, as at 32, or the like to signify the end of the auction on that item.

While the foregoing description includes detail that will enable those skilled in the art to practice the invention, it should be recognized that the description is illustrative in nature and that many modifications and variations will be apparent to those skilled in the art having the benefit of these teachings. It is accordingly intended that the invention herein be defined solely by the claims to be appended to the completed patent application, and that the claims be interpreted as broadly as permitted in light of the prior art.

I claim:

1. A method for conducting an on-line auction comprising the steps of:
(a) defining a short initial time period in which the auction on a particular item is to take place;
(b) closing the auction on the particular item at the end of the period, with the highest bidder obtaining the object subject to any reserve or minimum bid requirements unless a bid is received during a pre-defined end portion of the initial period; and
(c) extending the auction for a supplemental period if a bid is received during a pre-defined end portion of the auction period.

2. The auction method of claim 1 wherein step (c) includes the step of extending the auction for a supplemental period of fixed time duration.

3. The auction method of claim 2 wherein step (c) includes the step of extending the auction for a supplemental period of fixed time duration whose length is known in advance by the bidders.

4. The auction method of claim 1 wherein the supplemental period is less than the initial period in duration.

5. The auction method of claim 1 wherein steps (b) and (c) are repeated until no bid is received during the supplemental period then in effect

6. The auction method of claim 5 wherein the lengths of the supplemental periods are substantially the same with each extension.

7. The auction method of claim 6 wherein the lengths of the end portion is the same following

6. The auction method of claim 1 wherein the initial period is approximately 3 minutes in length.

7. The auction method of claim 1 wherein the supplemental period is approximately 1 minute in length.

8. The auction method of claim 1 wherein the end portion is approximately one minute in length.
